(19) United States
(12) Patent Application Publication
(10) Pub. No.: US 2026/0145692 A1
(43) Pub. Date: May 28, 2026

(54) MODE-DEPENDEND OVERTEMPERATURE PROTECTION

(71) Applicant: Infineon Technologies AG, Neubiberg (DE)

(72) Inventor: Stephan Donath, Neubiberg (DE)

(21) Appl. No.: 19/178,524

(22) Filed: Apr. 14, 2025

(30) Foreign Application Priority Data
May 22, 2024 (DE) 102024204726.0

(51) Int. Cl. B60W 50/029; B60W 50/02; G07C 5/02

(52) U.S. Cl. CPC B60W 50/029; B60W 50/0205; G07C 5/02; B60W 2050/0292

(57) ABSTRACT

A method for overtemperature protection of an electronic device having a plurality of operation modes is presented. The method may comprise of assigning temperature thresholds to the operation modes of the electronic device; determining a present operation mode of the electronic

device; determining a present temperature of at least a part of the electronic device; and declaring an overtemperature condition of the electronic device if the present temperature exceeds the temperature threshold assigned to the present operation mode of the electronic device. Further, an overtemperature protection circuit and a use of the overtemperature detection circuit and the method for overtemperature protection are presented.

### TECHNICAL FIELD

The present disclosure relates to a method for overtemperature protection, an overtemperature protection circuit and a use thereof.

### BACKGROUND

Overtemperature operation may generally destroy or at least damage electronic devices and specifically semiconductor devices. At least, overtemperature operation may reduce lifetime of such devices or may lead to operational failures. Thus, overtemperature detection and protection is typically required. However, certain circumstances may require overtemperature operation for avoiding greater damage, such as personal injuries for instance. Further, a risk of overtemperature operation may be tolerable, such as at least for a limited period of time. In such circumstances, it may be unfavorable to hold on to a fixed temperature threshold for overtemperature operation. Thus, there is a need for improving overtemperature protection and specifically for improving flexibility of temperature thresholds for overtemperature protection.

### SUMMARY

In a first aspect, a method for overtemperature protection of an electronic device having a plurality of operation modes is presented. The method comprises:
a) assigning temperature thresholds to the operation modes of the electronic device;
b) determining a present operation mode of the electronic device;
c) determining a present temperature of at least a part of the electronic device; and
d) declaring an overtemperature condition of the electronic device if the present temperature exceeds the temperature threshold assigned to the present operation mode of the electronic device.

In a further aspect, an overtemperature protection circuit is presented. The overtemperature protection circuit comprises at least one evaluation circuit. The evaluation circuit is configured for assigning temperature thresholds to operation modes of an electronic device. The evaluation circuit is further configured for determining a present operation mode of the electronic device. The overtemperature protection circuit further comprises at least one temperature comparator. The temperature comparator is configured for receiving a temperature signal referring to a present temperature of at least a part of the electronic device. The temperature comparator is further configured for comparing the present temperature to a temperature threshold.

In a further aspect, a use of a method for overtemperature protection and/or of an overtemperature protection circuit is presented for an automotive application.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 to 3 schematically illustrate examples of an overtemperature protection circuit according to the present disclosure; and

FIG. 4 illustrates a flow chart of an example of a method for overtemperature protection according to the present disclosure.

### DETAILED DESCRIPTION

The examples described herein provide considerable advantages. Specifically, the presented methods and devices may allow more flexibility for overtemperature protection by assigning individual temperature thresholds to different operation modes of an electronic device. Thus, for each present operation mode, a customized and appropriate temperature threshold may be utilized for overtemperature protection in accordance with the respective requirements of the operation mode. As an example, in a normal operation mode, a standard temperature threshold may be used, which may ensure that all components of the electronic device are not thermally stressed or at least not excessively thermally stressed. However, some components or eventually some materials of the electronic device may be more robust with respect to thermal stress. Further, less rugged components or materials may cope with overtemperature at least for a limited period of time.

Thus, in special operation modes of the electronic device, for instance in an emergency mode, an operation at higher temperatures may be tolerable and even advisable in order to prevent greater damage, such as personal injury for instance. As an example, the electronic device may be used for an automotive application, such as for controlling a motor or a light emitting diode. A failure of a drive motor of a vehicle or a headlight of the vehicle when travelling at full speed may, in the worst case, be life-threatening and should therefore typically be avoided at all costs. This may even include accepting damage to the electronic device controlling the motor or the light emitting diode. Thus, in such an operation mode, a different temperature threshold and specifically a higher temperature threshold compared to the normal operation mode may be preferred.

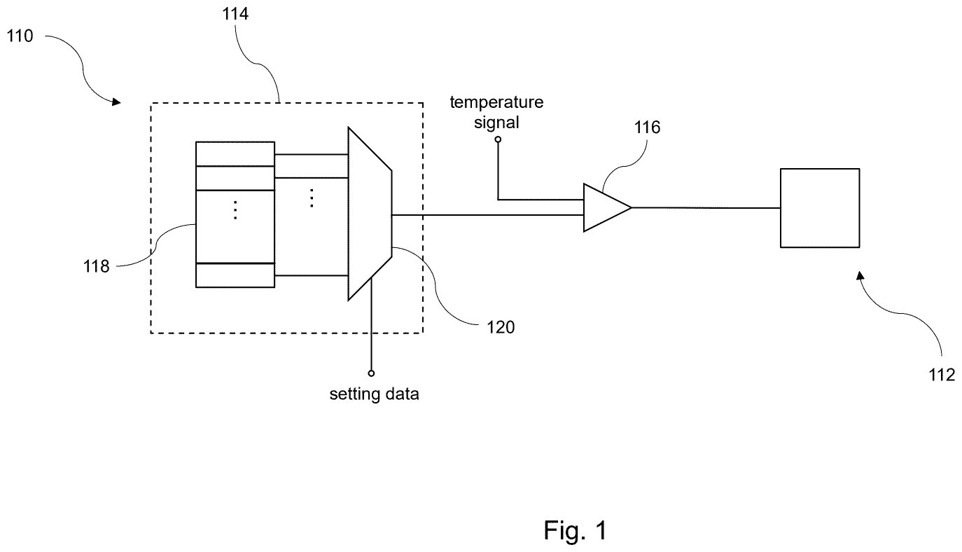

FIG. 1 schematically illustrates an example of an overtemperature protection circuit 110 in conjunction with a monitored electronic device 112. Thus, the overtemperature protection circuit 110 may be configured for detecting an overtemperature condition of the electronic device 112, specifically a damaging overtemperature condition or at least a significantly damaging overtemperature condition of the electronic device 112. The overtemperature condition may refer to a state in which the electronic device 112 or at least a part thereof has a temperature causing damage or at least significant damage to the electronic device 112 or a failure or a malfunctioning of the electronic device 112. Further, the overtemperature protection circuit 110 may be configured for protecting the electronic device 112 from overtemperature operation, specifically from damage or failure due to overtemperature operation. The overtemperature protection 110 may specifically be configured for protecting the electronic device 112 from overtemperature operation by outputting an exceeding of a temperature threshold corresponding to the overtemperature condition to the electronic device 112 and/or by initiating a reaction to the overtemperature condition. As an example, the reaction may comprise triggering a safe state of the electronic device 112, such as an off state. Additionally or alternatively, the reaction may for instance comprise activating a cooling of the electronic device 112.

In principle, the electronic device 112 may be an arbitrary device comprising electronic components such as transistors, diodes, resistors, capacitors or inductors. Specifically, the electronic device 112 may be or may comprise a semiconductor device, more specifically a power semiconductor device. Silicon, silicon carbide or gallium nitride may for instance be used as semiconductor material. The electronic device 112 may also be or may comprise an integrated circuit. The electronic device 112 may be configured for directly or indirectly controlling an application, specifically an automotive application, more specifically at least one of a motor and a light emitting diode. Thus, the electronic device 112 may be used in a vehicle. Specifically, the electronic device 112 may be implemented within an electronic control system of the vehicle. Correspondingly, the overtemperature protection circuit 110 or also a method for overtemperature protection of the electronic device 112, which will be described in further detail below, may be used for vehicles, such as in an electronic control system of the vehicle. Specifically, the overtemperature protection circuit 110 and/or the method for overtemperature protection of the electronic device 112 may be used for overtemperature protection of an automotive application or for overtemperature protection within an automotive application. Generally, other applications may of course also be feasible.

As FIG. 1 shows, the overtemperature protection circuit 110 comprises an evaluation circuit 114 and a temperature comparator 116. The overtemperature protection circuit 110 may specifically be an integrated circuit. Thus, the evaluation circuit 114 and the temperature comparator 116 and optionally also further components may be assembled and at least partially interconnected on a semiconductor chip, such as a silicon chip or a silicon carbide chip or a gallium nitride chip. The overtemperature protection circuit 110 may even form an integrated circuit together with the electronic device 112. The evaluation circuit 114 is configured for assigning temperature thresholds to operation modes of the electronic device 112 and for determining a present operation mode of the electronic device 112. The temperature comparator 116 is configured for receiving a temperature signal referring to a present temperature of at least a part of the electronic device 112 and for comparing the present temperature to a temperature threshold. Specifically, the temperature comparator 116 may be configured for comparing the present temperature to a temperature threshold assigned to a present operation mode of the electronic device 112. Thus, the temperature comparator 116 may be provided with the corresponding temperature threshold by the evaluation circuit 114 for comparing it to the present temperature indicated by the temperature signal.

The temperature comparator 116 may generally be or may comprise an electronic circuit configured for comparing two electronic properties, specifically two voltages, referring to temperature values. Thus, a first voltage may refer to the present temperature at the electronic device 112 and a second voltage may refer to the temperature threshold. An output of the temperature comparator 116 may indicate which voltage is higher and thus if the present temperature at the electronic device 112 is higher than the temperature threshold. Thus, the temperature comparator 116 may indicate if the present temperature at the electronic device 112 exceeds or goes above the temperature threshold. After comparing the present temperature to the temperature threshold, the temperature comparator 116 may then output to the electronic device 112 if the present temperature exceeds the temperature threshold, thereby e.g. switching the electronic device 112 off. Thus, the temperature comparator 116 may be configured for outputting an overtemperature condition to the electronic device 112 if the present temperature exceeds the temperature threshold and/or for initiating a reaction to the overtemperature condition if present.

For the evaluation circuit 114, several embodiments are generally conceivable. As FIG. 1 shows, the evaluation circuit 114 may for instance comprise a register 118. The register 118 may be configured for storing a plurality of temperature thresholds. The temperature thresholds may for instance be stored as digital data or as analog voltages. Each temperature threshold may refer to a specific operation mode of the electronic device 112. The evaluation circuit 114 may further comprise a multiplexer 120. The multiplexer 120 may be configured for outputting the temperature threshold of a present operation mode of the electronic device 112 to the temperature comparator 116. Thus, the evaluation circuit 114 may comprise a data input for receiving setting data of the electronic device 112. The setting data may indicate a present operation mode of the electronic device 112. Thus, depending on the present operation mode of the electronic device 112, the evaluation circuit 114 or specifically the multiplexer 120 may output a different temperature threshold from the register 118 to the temperature comparator 116.

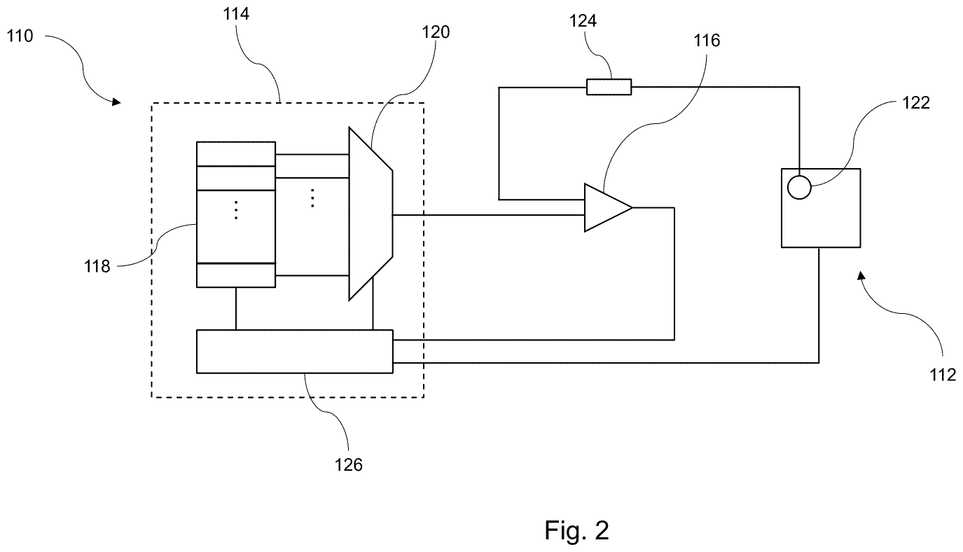

FIG. 2 schematically illustrates a further example of the overtemperature protection circuit 110, which corresponds to the example illustrated in FIG. 1 at least to a large extent. Thus, for the description of FIG. 2, reference may also be made to the description of FIG. 1 for further details. As FIG. 2 shows, the overtemperature protection circuit 110 may further comprise a temperature sensor 122. The temperature sensor 122 may be configured for monitoring the present temperature of the electronic device 112 or at least of a part thereof. The temperature sensor 122 may further be configured for sending a corresponding temperature signal. Specifically, the temperature sensor 122 may be configured for sending a temperature signal referring to the present temperature to the temperature comparator 116. For such purpose, the temperature sensor 122 may be located at the electronic device 112. The temperature sensor 122 may for instance be or may comprise a thermistor, such as a negative-temperature-coefficient thermistor or a positive-temperature-coefficient thermistor.

Further, the overtemperature protection circuit 110 may comprise an analog-to-digital converter 124. The temperature sensor 122 may specifically be configured for sending an analog temperature signal. The analog-to-digital converter 124 may be configured for converting the analog temperature signal to a digital temperature signal, specifically for further processing. Thus, the temperature sensor 122 may either directly provide an analog temperature signal to the temperature comparator 116 or the temperature sensor 122 may first provide the analog temperature signal to the analog-to-digital converter 124, the analog-to-digital converter 124 may convert the analog temperature signal to a digital temperature signal and may then provide the digital temperature signal to the temperature comparator 116. Thus, the overtemperature protection circuit 110 may at least partially be a digital device. In other words, at least some of the components of the overtemperature protection circuit 110 may be digital components. Specifically, at least one of the evaluation circuit 114 and the temperature comparator 116 may be a digital component. In principle, the overtemperature detection circuit 110 may however also be an analog device. In other words, the components of the overtemperature detection circuit 110 may also be analog components.

The evaluation circuit 114 may further specifically comprise a controller 126. The controller 126 may for instance be or may comprise a microcontroller or at least a processor, e.g. a central processing unit or the like. The controller 126 may be configured for writing and/or rewriting the register 118. Specifically, the controller 126 may be configured for writing a specific temperature threshold for a specific operation mode in the register 118. Thus, the controller 126 may be configured for controlling the register 118. The controller 126 may further specifically be configured for controlling or monitoring the electronic device 112, specifically an operation mode of the electronic device 112. Thus, the controller 126 may always know the operation mode of the electronic device 112 and may for instance feed the multiplexer 120 accordingly with setting data of the electronic device 112, such that the multiplexer 120 provides the temperature comparator 116 with the corresponding temperature threshold from the register 118. In other words, the controller 126 may further be configured for controlling the multiplexer 120, specifically for providing the setting data of the electronic device 112 to the multiplexer 120.

The temperature comparator 116 may then again compare the temperature threshold with the present temperature at the electronic device 112 and may output a result of the comparison to the controller 126. Thus, in case the temperature comparator 116 indicates that the present temperature exceeds the temperature threshold assigned to the present operation mode, the controller 126 may initiate a reaction to the overtemperature condition. In other words, the controller 126 may further be configured for initiating the reaction to the overtemperature condition. As an example, the controller 126 may trigger a safe state of the electronic device 112. For instance, the controller 126 may then switch the electronic device 112 off. Further, the controller 126 may change the operation mode of the electronic device 112, such as from a normal operation mode to a special operation mode. The controller 126 may also activate and/or control further elements in connection with the overtemperature condition, such as a cooling element for actively cooling the electronic device 112.

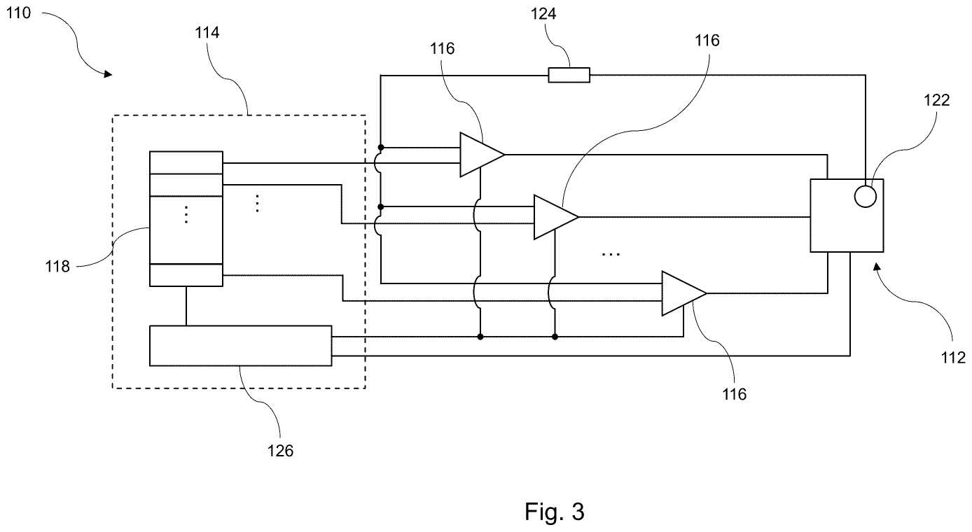

FIG. 3 schematically illustrates a further example of the overtemperature protection circuit 110, which again corresponds to the examples illustrated in FIGS. 1 and 2 at least for many aspects. Thus, for the description of FIG. 3, reference may also be made to the description of FIGS. 1 and 2 for further details. As FIG. 3 shows, the overtemperature protection circuit 110 may also comprise a plurality of temperature comparators 116. A first temperature comparator 116 may be configured for comparing the present temperature of the semiconductor device 112 to a first temperature threshold referring to a first operation mode, such as a first temperature threshold stored in the register 118. A second temperature comparator 116 may then be configured for comparing the present temperature to a second temperature threshold referring to a second operation mode and so on. As an example, the controller 126 may then switch on the according temperature comparator 116 for the present operation mode and switch off the remaining temperature comparators 116. Thus, the controller 126 may further generally be configured for controlling the at least one temperature comparator 116 or at least one of the plurality of temperature comparators 116.

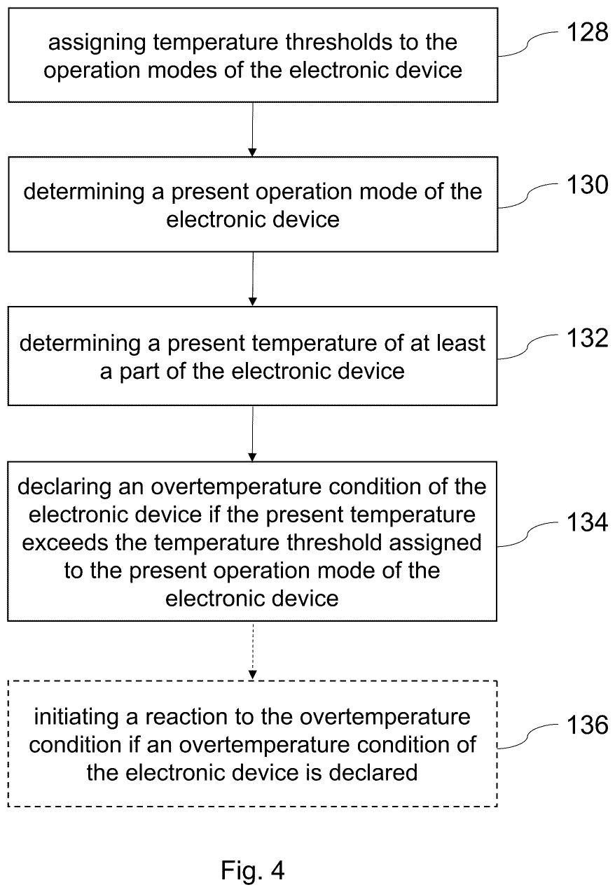

FIG. 4 illustrates a flow chart of an example of a method for overtemperature protection. The method comprises the following method steps. The presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion. The method may at least partially be computer-implemented. Thus, one or more of the following method steps may be computer-implemented.
a) (denoted by reference numeral 128) assigning temperature thresholds to the operation modes of the electronic device 112;
b) (denoted by reference numeral 130) determining a present operation mode of the electronic device 112;
c) (denoted by reference numeral 132) determining a present temperature of at least a part of the electronic device 112; and
d) (denoted by reference numeral 134) declaring an overtemperature condition of the electronic device 112 if the present temperature exceeds the temperature threshold assigned to the present operation mode of the electronic device 112.

Specifically, in step a), the temperature thresholds assigned to different operation modes may at least partially be different from each other. More specifically, in step a), the temperature thresholds assigned to different operation modes may each be different from each other. Thus, the operation modes may specifically be assigned individual temperature thresholds. Further, step a) may comprise assigning a temperature threshold to each operation mode of the electronic device 112. Thus, step a) may specifically comprise assigning an individual temperature threshold to each operation mode of the electronic device 112. In other words, each operation mode of the electronic device 112 may be assigned an individual temperature threshold. However, in principle, one or more operation modes may also not be assigned with a threshold voltage and/or two or more operation modes may be assigned with the same temperature threshold.

The operation modes may comprise at least one normal operation mode and at least one special operation mode. The temperature threshold assigned to the normal operation mode may specifically be lower than the temperature threshold assigned to the special operation mode. The normal operation mode may be an operation mode which is typical or conventional or standard for the electronic device 112. Thus, unless an unusual event occurs, the electronic device 112 should typically be in the normal operation mode, which should typically be the case most of the time. Thus, the electronic device 112 may specifically be designed for operating in the normal operation mode, at least predominantly. There may be more than one normal operation mode. The electronic device 112 may have a plurality of normal operation modes, each one e.g. referring to a different standard operation of the electronic device 112. As an example, driving a motor in forward direction may be a first normal operation mode and driving the motor in backward direction may be a second normal operation mode of the electronic device 112. As a further example, driving a light emitting diode at a first intensity may be a first normal operation mode and driving the light emitting diode at a second intensity may be a second normal operation mode of the electronic device 112.

The temperature threshold assigned to the normal operation mode may be tailored to at least one material comprised by the electronic device 112 or more specifically to a temperature resistance of the material. Specifically, the temperature threshold assigned to the normal operation mode may be tailored to a least temperature resistant material of the electronic device 112. Thus, it may be ensured that in the normal operation mode no component of the electronic device is thermally stressed or at least excessively thermally stressed, which may ensure long lifetime and/or ideal functionality. As an example, the temperature threshold assigned to the normal operation mode may be in a range from 80° C. to 270° C., specifically from 100° C. to 200° C., more specifically from 130° C. to 175° C. As a specific example, the temperature threshold assigned to the normal operation mode may be 135° C., at which a printed circuit board may for instance be operated without excessive thermal stress. As indicated, the operation modes may also comprise a plurality of normal operation modes. Thus, the normal operation modes may each have different or at least partially different temperature thresholds in the above-mentioned temperature ranges.

The special operation mode may be a non-normal operation mode or an operation mode for exceptional situations, such as emergency situations. Thus, in case of an unusual event, which does not correspond to a standard operation of the electronic device 112, the electronic device 112 may switch to the special operation mode. The special operation mode may be selected from the group consisting of: an emergency operation mode; a limp home mode; a start mode, specifically a motor start mode; a transient load mode, specifically a capacitor charging mode; a braking mode; specifically an emergency braking mode; an acceleration mode; a boost mode. In the emergency mode, overtemperature operation may be accepted in order to prevent greater damage in an emergency situation. Thus, in the braking mode and specifically in the emergency braking mode of a vehicle, overtemperature operation may specifically be accepted in order to prevent an accident. In the limp home mode, overtemperature operation may for instance be accepted for bringing a vehicle home or to a repair shop, specifically in order to not lose functionality during a ride. In the start mode, in the transient load mode, in the acceleration mode or also in the boost mode, overtemperature operation due to higher currents, e.g. inrush currents, causing higher temperatures may be accepted, specifically since such processes may be temporarily limited. Further, certain situations, specifically emergency situations, may require boosting or amplifying certain functionalities, such as for safety reasons. As an example, a light intensity or also a sound intensity, such as for a warning sound, may be amplified for signaling a potential danger. Further options for special operation modes may of course generally also be conceivable.

A temperature threshold assigned to the special operation mode may be tailored to at least one material comprised by the electronic device 112 or more specifically to a temperature resistance of the material. Specifically, a temperature threshold assigned to the special operation mode may be tailored to a most temperature resistant material of the electronic device 112. Thus, it may at least be ensured that even in an exceptional situation, such as in an emergency situation, the electronic device 112 is not directly and completely overloaded and retains at least essential functionality. As an example, the temperature threshold assigned to the special operation mode may be in a range from 100° C. to 400° C., specifically from 150° C. to 300° C., more specifically from 170° C. to 200° C. As a specific example, the temperature threshold assigned to the special operation mode may be 175° C., at which a power semiconductor device may for instance be operated without excessive thermal stress. As indicated, the operation modes may also comprise a plurality of special operation modes. Thus, the special operation modes may each have different or at least partially different temperature thresholds in the above-mentioned temperature ranges.

Thus, a temperature threshold assigned to the special operation mode may specifically be higher than a temperature threshold assigned to the normal operation mode. Specifically, a temperature threshold assigned to the special operation mode, compared to a temperature threshold assigned to the normal operation mode, may be tailored to a higher characteristic material temperature, specifically to a higher material transition temperature. This may be the case, because the temperature threshold assigned to the special operation mode may be tailored to another material compared to the temperature threshold assigned to the normal operation mode as already indicated above. Additionally or alternatively, this may however also be the case, because the temperature threshold assigned to the special operation mode may be tailored to another characteristic material temperature of the same material.

The method may further comprise the following method step:
e) initiating a reaction to the overtemperature condition if an overtemperature condition of the electronic device is declared.

The reaction may comprise triggering a safe state of the electronic device 112. The safe state may be an off state of the electronic device 112. In other words, in case of a declared overtemperature condition for the present operation mode, the electronic device may be switched off. Other safe states may however also be feasible. The safe state may in principle also be an on state, such as an on state with reduced power consumption. Additionally or alternatively, the reaction may comprise activating a cooling of the electronic device 112. Thus, a cooling element, for instance a fan or a thermoelectric cooler such as a Peltier cooler, may be switched on and actively cool the electronic device 112. For further details regarding the method for overtemperature protection, reference may also be made to the description of the overtemperature protection circuit 110 above.

In addition to the above described examples, the following examples are disclosed herein:
Example 1: A method for overtemperature protection of an electronic device having a plurality of operation modes, the method comprising:
a) assigning temperature thresholds to the operation modes of the electronic device;
b) determining a present operation mode of the electronic device;
c) determining a present temperature of at least a part of the electronic device; and
d) declaring an overtemperature condition of the electronic device if the present temperature exceeds the temperature threshold assigned to the present operation mode of the electronic device.
Example 2: The method according to the preceding Example, wherein the temperature thresholds assigned to different operation modes are at least partially different from each other.
Example 3: The method according to any one of the preceding Examples, wherein step a) comprises assigning a temperature threshold to each operation mode of the electronic device.
Example 4: The method according to any one of the preceding Examples, wherein the operation modes comprise at least one normal operation mode and at least one special operation mode.
Example 5: The method according to the preceding Example, wherein the special operation mode is selected from the group consisting of: an emergency operation mode; a limp home mode; a start mode, specifically a motor start mode; a transient load mode, specifically a capacitor charging mode; a braking mode, specifically an emergency braking mode; an acceleration mode; a boost mode.
Example 6: The method according to any one of the two preceding Examples, wherein the temperature threshold assigned to the normal operation mode is lower than the temperature threshold assigned to the special operation mode.
Example 7: The method according to any one of the three preceding Examples, wherein the temperature threshold assigned to the normal operation mode is tailored to at least one material comprised by the electronic device.
Example 8: The method according to any one of the four preceding Examples, wherein the temperature threshold assigned to the normal operation mode is tailored to a least temperature resistant material of the electronic device.
Example 9: The method according to any one of the five preceding Examples, wherein the temperature threshold assigned to the normal operation mode is in a range from 80° C. to 270° C., specifically from 100° C. to 200° C., more specifically from 130° C. to 175° C.
Example 10: The method according to any one of the six preceding Examples, wherein the temperature threshold assigned to the normal operation mode is 135° C.
Example 11: The method according to any one of the seven preceding Examples, wherein a temperature threshold assigned to the special operation mode is tailored to at least one material comprised by the electronic device.
Example 12: The method according to any one of the eight preceding Examples, wherein a temperature threshold assigned to the special operation mode is tailored to a most temperature resistant material of the electronic device.
Example 13: The method according to any one of the nine preceding Examples, wherein a temperature threshold assigned to the special operation mode, compared to a temperature threshold assigned to the normal operation mode, is tailored to a higher characteristic material temperature, specifically to a higher material transition temperature.
Example 14: The method according to any one of the ten preceding Examples, wherein the temperature threshold assigned to the special operation mode is in a range from 100° C. to 400°C., specifically from 150° C. to 300° C., more specifically from 170° C. to 200° C.
Example 15: The method according to any one of the eleven preceding Examples, wherein the temperature threshold assigned to the special operation mode is 175° C.
Example 16: The method according to any one of the preceding Examples, further comprising:
e) initiating a reaction to the overtemperature condition if an overtemperature condition of the electronic device is declared.
Example 17: The method according to the preceding Example, wherein the reaction comprises triggering a safe state of the electronic device.
Example 18: The method according to the preceding Example, wherein the safe state is an off state of the electronic device.
Example 19: The method according to any one of the three preceding Examples, wherein the reaction comprises activating a cooling of the electronic device.
Example 20: The method according to any one of the preceding Examples, wherein the electronic device is configured for directly or indirectly controlling an application, specifically an automotive application, more specifically at least one of a motor and a light emitting diode.
Example 21: The method according to any one of the preceding Examples, wherein the electronic device comprises a semiconductor device.
Example 22: The method according to any one of the preceding Examples, wherein the electronic device comprises an integrated circuit.
Example 23: The method according to any one of the preceding Examples, wherein the method is at least partially computer implemented.
Example 24: An overtemperature protection circuit comprising:
at least one evaluation circuit configured for assigning temperature thresholds to operation modes of an electronic device and for determining a present operation mode of the electronic device; and
at least one temperature comparator configured for receiving a temperature signal referring to a present temperature of at least a part of the electronic device and for comparing the present temperature to a temperature threshold.
Example 25: The overtemperature protection circuit according to the preceding Example, wherein the overtemperature protection circuit is configured for performing a method for overtemperature protection of an electronic device according to any one of the preceding method Examples.
Example 26: The overtemperature protection circuit according to any one of the preceding Examples referring to an overtemperature protection circuit, wherein the temperature comparator is configured for comparing the present temperature to a temperature threshold assigned to a present operation mode of the electronic device.
Example 27: The overtemperature protection circuit according to any one of the preceding Examples referring to an overtemperature protection circuit, wherein the temperature comparator is configured for outputting an overtemperature condition to the electronic device if the present temperature exceeds the temperature threshold.
Example 28: The overtemperature protection circuit according to any one of the preceding Examples referring to an overtemperature protection circuit, further comprising:
at least one analog-to-digital converter configured for converting an analog temperature signal to a digital temperature signal.
Example 29: The overtemperature protection circuit according to any one of the preceding Examples referring to an overtemperature protection circuit, wherein at least one of the evaluation circuit and the temperature comparator is a digital component.
Example 30: The overtemperature protection circuit according to any one of the preceding Examples referring to an overtemperature protection circuit, further comprising:
at least one temperature sensor configured for monitoring the present temperature of the electronic device or at least of a part thereof and for sending a corresponding temperature signal.
Example 31: The overtemperature protection circuit according to the preceding Example, wherein the temperature sensor is located at the electronic device.
Example 32: The overtemperature protection circuit according to any one of the preceding Examples referring to an overtemperature protection circuit, wherein the evaluation circuit comprises at least one register for storing a plurality of temperature thresholds.
Example 33: The overtemperature protection circuit according to any one of the preceding Examples referring to an overtemperature protection circuit, wherein the evaluation circuit comprises at least one multiplexer configured for outputting the temperature threshold of a present operation mode of the electronic device to the temperature comparator.
Example 34: The overtemperature protection circuit according to any one of the preceding Examples referring to an overtemperature protection circuit, wherein the evaluation circuit, specifically the multiplexer, comprises at least one data input for receiving setting data of the electronic device.
Example 35: The overtemperature protection circuit according to the preceding Example, wherein the setting data indicate a present operation mode of the electronic device.
Example 36: The overtemperature protection circuit according to any one of the preceding Examples referring to an overtemperature protection circuit, wherein the evaluation circuit comprises at least one controller for controlling the electronic device, specifically an operation mode of the electronic device.
Example 37: The overtemperature protection circuit according to any one of the preceding Examples referring to an overtemperature protection circuit, wherein the overtemperature protection circuit is an integrated circuit.
Example 38: The overtemperature protection circuit according to any one of the preceding Examples, wherein the overtemperature protection circuit comprises at least two temperature comparators, wherein a first temperature comparator is configured for comparing the present temperature to a first temperature threshold referring to a first operation mode, wherein a second temperature comparator is configured for comparing the present temperature to a second temperature threshold referring to a second operation mode.
Example 39: A use for an automotive application of at least one of a method for overtemperature protection according to any one of the preceding method Examples and an overtemperature protection circuit according to any one of the preceding Examples referring to an overtemperature protection circuit.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1. A method for overtemperature protection of an electronic device having a plurality of operation modes, the method comprising:
a) assigning temperature thresholds to the operation modes of the electronic device;
b) determining a present operation mode of the electronic device;
c) determining a present temperature of at least a part of the electronic device and
d) declaring an overtemperature condition of the electronic device if the present temperature exceeds the temperature threshold assigned to the present operation mode of the electronic device.

2. The method according to claim 1, wherein the temperature thresholds assigned to different operation modes are at least partially different from each other.

3. The method according to claim 1, wherein step a) comprises assigning a temperature threshold to each of the operation modes of the electronic device

4. The method according to claim 1, wherein the operation modes comprise at least one normal operation mode and at least one special operation mode.

5. The method according to claim 4, wherein the special operation mode is selected from the group consisting of: an emergency operation mode; a limp home mode; a start mode, specifically a motor start mode; a transient load mode, specifically a capacitor charging mode; a braking mode; specifically an emergency braking mode; an acceleration mode; a boost mode.

6. The method according to claim 4, wherein the a temperature threshold assigned to the normal operation mode is lower than a the temperature threshold assigned to the special operation mode.

7. The method according to claim 4, wherein a temperature threshold assigned to the special operation mode, compared to a temperature threshold assigned to the normal operation mode, is tailored to a higher material transition temperature.

8. The method according to claim 1, further comprising:
e) initiating a reaction to the overtemperature condition if an overtemperature condition of the electronic device is declared.

9. The method according to claim 8, wherein the reaction comprises triggering a safe state of the electronic device

10. The method according to claim 8, wherein the reaction comprises activating a cooling of the electronic device

11. An overtemperature protection circuit comprising:
at least one evaluation circuit configured to assign temperature thresholds to operation modes of an electronic device and to determine a present operation mode of the electronic device; and
at least one temperature comparator configured to receive a temperature signal referring to a present temperature of at least a part of the electronic device and to compare the present temperature to a temperature threshold.

12. The overtemperature protection circuit according to claim 11, wherein the temperature comparator is configured to output an overtemperature condition to the electronic device if the present temperature exceeds the temperature threshold.

13. The overtemperature protection circuit (110) according to claim 11, further comprising:
at least one analog-to-digital converter configured to convert an analog temperature signal to a digital temperature signal.

14. The overtemperature protection circuit according to claim 11, wherein at least one of the evaluation circuit and the temperature comparator comprises a digital component.

15. The overtemperature protection circuit according to claim 11, further comprising:
at least one temperature sensor configured to monitor the present temperature of the electronic device or at least of a part thereof and to send a corresponding temperature signal.

16. The overtemperature protection circuit according to claim 11, wherein the evaluation circuit comprises at least one register for storing a plurality of temperature thresholds.

17. The overtemperature protection circuit according to claim 11, wherein the evaluation circuit comprises at least one multiplexer configured to output the temperature threshold of a present operation mode of the electronic device to the temperature comparator.

18. The overtemperature protection circuit according to claim 11, wherein the evaluation circuit comprises at least one data input for receiving setting data of the electronic device, wherein the setting data indicates the present operation mode of the electronic device.

19. The overtemperature protection circuit according to claim 11, wherein the evaluation circuit comprises at least one controller for controlling an operation mode of the electronic device.

20. The overtemperature protection circuit of claim 11, wherein the overtemperature protection circuit comprises an automotive circuit.
